(19) United States
(12) Patent Application Publication
(10) Pub. No.: US 2010/0270446 A1
(43) Pub. Date: Oct. 28, 2010

(54) Universal Adjustable Box Bracket

(76) Inventor: Bruce G. Phillips, Tempe, AZ (US)

Correspondence Address: AVERILL & GREEN, 8244 PAINTER AVE., WHITTIER, CA, 90602, US

(21) Appl. No.: 12/769,037

(22) Filed: Apr. 28, 2010

Related U.S. Application Data
(60) Provisional application No. 61/173,562, filed on Apr. 28, 2009.

(51) Int. Cl. F16M 13/00

(52) U.S. Cl. 248/201

(57) ABSTRACT

A box bracket includes mounting brackets with upper and lower lateral telescoping arms and a sliding mount. The mounting bracket includes an end piece for attaching to a vertical stud, and inner and outer lateral arms overlapping with arms of an opposing mounting bracket to form the telescoping arms. The mounting bracket may be used as a left or right mounting bracket. The sliding mount includes a forward facing face for mounting an electrical box and vertically spaced apart mouths on left and right sides of the sliding mount, the upper and lower telescoping arms passing through the mouths. The mouths are formed in mouth frames, and after positioning the sliding mounts, the mouth frames may be bent inward against the telescoping arms to hold the position of the sliding mount on the arms. One or more sliding mounts may reside on a single box bracket subject to stud spacing.

The present application claims the priority of U.S. Provisional Patent Application Ser. No. 61/173,562 filed Apr. 28, 2009, which application is incorporated in its entirety herein by reference.

### BACKGROUND OF THE INVENTION

The present invention relates to brackets for electrical boxes and in particular to a telescoping adjustable bracket for mounting an electrical box between studs.

Often, a need exists to mount an electrical box on a wall in a position between vertical studs. For example, in a kitchen, cabinet positions may require that an outlet or switch be in a certain location for easy access. Further, it is common in construction to require multiple boxes between two adjacent vertical studs, for example, one for 115 volt power, and one for low-voltage such as category 5 cable. Such multiple boxes are common in hospital rooms behind patient beds and above desks in hotel rooms. In these instances, the electrical box may not be next to a stud, and a bracket is required which reached between adjacent vertical studs. Further, studs may not be precisely spaced apart, so a need has existed for an adjustable (e.g., telescoping) bracket to reach between the vertical studs.

U.S. Pat. No. 6,666,419 for “Bracket Assembly for Mounting Electrical Box Between Two Building Studs” discloses a bracket with flattened telescoping upper legs 132 and 142 and lower legs 136 and 156. The telescoping legs are sandwiched between a plaster ring 30 and an electrical box 20. While the bracket assembly of the '419 patent is satisfactory in many application, it does not allow positioning the electrical box along the full length of the bracket because the electrical box can not straddle the two different material thicknesses without leaving an excessive gap between the electrical box and the plaster ring.

### BRIEF SUMMARY OF THE INVENTION

The present invention addresses the above and other needs by providing a box bracket which includes mounting brackets with upper and lower lateral telescoping arms and a sliding mount. The mounting bracket includes an end piece for attaching to a vertical stud, and inner and outer lateral arms overlapping with arms of an opposing mounting bracket to form the telescoping arms. The mounting bracket may be used as a left or right mounting bracket. The sliding mount includes a forward facing face for mounting an electrical box and vertically spaced apart mouths on left and right sides of the sliding mount, the upper and lower telescoping arms passing through the mouths. The mouths are formed in mouth frames, and after positioning the sliding mounts, the mouth frames may be bent inward against the telescoping arms to hold the position of the sliding mount on the arms. One or more sliding mounts may reside on a single box bracket subject to stud spacing.

In accordance with one aspect of the invention, there is provided a multi-box bracket having telescoping arms, the bracket allowing same or different sized electrical boxes to be installed on the telescoping arms across the full width between two adjacent vertical studs.

In accordance with another aspect of the invention, there is provided a sliding mount with mouths for sliding over telescoping arms. The mouths are in mouth frames, and the mouth frames may be bent against the arms, after positioning the sliding mount, to resist movement of the sliding mount on the arms.

In accordance with another aspect of the invention, there is provided a sliding mount with fixing screw holes in a face of the sliding mount. After positioning the sliding mount on the arms, fixing screws passing through the fixing screw holes are tightened against the arms to resist movement of the sliding mount on the arms.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a narrow telescoping box bracket according to the present invention in a retracted position.

FIG. 2 is a wide telescoping box bracket according to the present invention in a retracted position.

FIG. 3 is a perspective view of the narrow telescoping box bracket according to the present invention in an extended position.

FIG. 4A is a front view of the narrow telescoping box bracket according to the present invention in the extended position.

FIG. 4B is a top view of the narrow telescoping box bracket according to the present invention in the extended position.

FIG. 4C is an end view of the narrow telescoping box bracket according to the present invention in the extended position.

FIG. 5 is a perspective view of a narrow mounting bracket according to the present invention of the narrow telescoping box bracket.

FIG. 6A is a top view of the narrow mounting bracket according to the present invention.

FIG. 6B is an end view of the narrow mounting bracket according to the present invention.

FIG. 6C is a top view of the narrow mounting bracket according to the present invention.

FIG. 7 is a perspective view of a sliding mount according to the present invention of the narrow telescoping box bracket.

FIG. 8A is a front view of the sliding mount according to the present invention.

FIG. 8B is a top view of the sliding mount according to the present invention.

FIG. 8C is a side view of the sliding mount according to the present invention.

FIG. 9A is a side view of an arm of the mounting bracket passing through a mouth in a mouth frame of the sliding mount with the sliding mount free to slide on the arm according to the present invention.

FIG. 9B is a top view of the arm of the mounting bracket passing through the mouth in the mouth frame of the sliding mount with the sliding mount free to slide on the arm.

FIG. 10A is a side view of the arm of the mounting bracket passing through the mouth in a mouth frame of the sliding mount with a point on a rear edge of the mouth bent away from the arm allowing the sliding mount free to slide on the arm according to the present invention.

FIG. 10B top view of the arm of the mounting bracket passing through a mouth in the mouth frame of the sliding mount with the point on the rear edge of the mouth bent away from the arm allowing the sliding mount free to slide on the arm.

FIG. 11A is a side view of the arm of the mounting bracket passing through the mouth in the mouth frame of the sliding mount with the mouth frame bent towards the arm restricting the sliding mount free to slide on the arm according to the present invention.

FIG. 11B top view of the arm of the mounting bracket passing through a mouth in the mouth frame of the sliding mount with the mouth frame bent towards the arm restricting the sliding mount free to slide on the arm.

FIG. 12A is a side view of the arm of the mounting bracket passing through the mouth in the mouth frame of the sliding mount with the mouth frame bent towards the arm and the point on the rear edge of the mouth contacting the arm thereby restricting the sliding mount free to slide on the arm according to the present invention.

FIG. 12B top view of the arm of the mounting bracket passing through the mouth in the mouth frame of the sliding mount with the mouth frame bent towards the arm and the point on the rear edge of the mouth contacting the arm thereby restricting the sliding mount free to slide on the arm according to the present invention.

FIG. 13A shows a front view of a second sliding mount with holes for fixing screws according to the present invention.

FIG. 13B shows an edge view of the second sliding mount with screws passing though the holes and engaging the arms for fixing the position of the sliding mount in the arms according to the present invention.

FIG. 14 shows a third sliding mount including support for EMT and armored cable according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

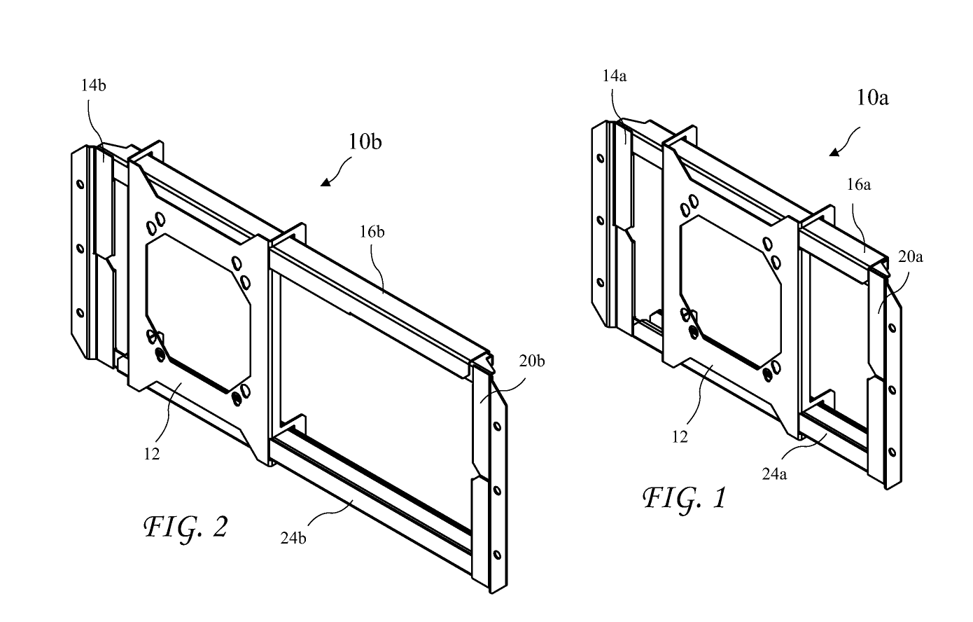

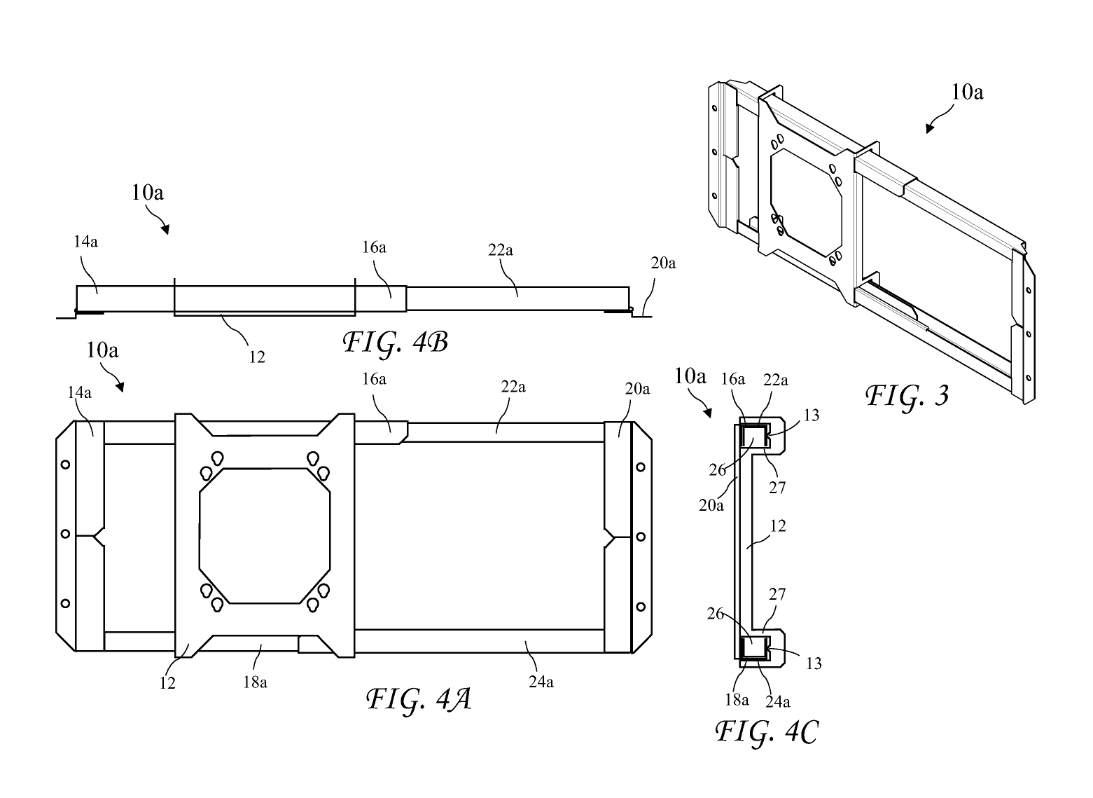

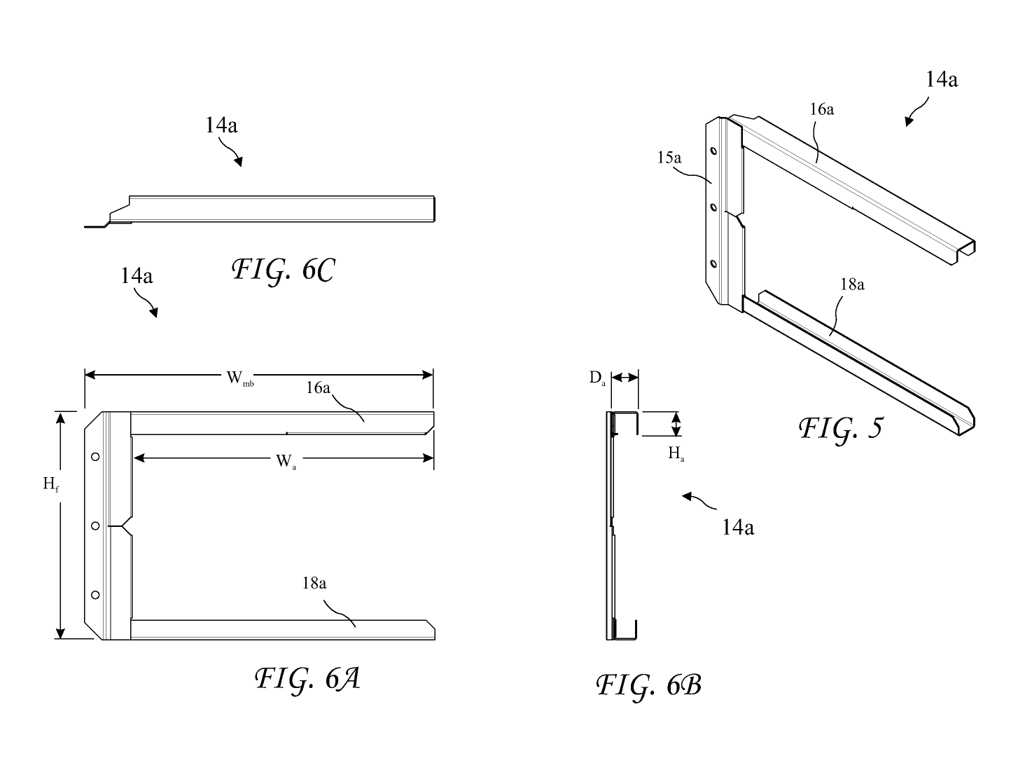

A narrow telescoping box bracket 10a according to the present invention is shown in FIG. 1 in a retracted position and a wide telescoping box bracket 10b according to the present invention is shown in FIG. 2 in a retracted position. The telescoping box brackets 10a and 10b include a sliding mount 12 and a pair of mounting brackets 15 (see FIG. 5). The narrow telescoping box bracket 10a includes mounting brackets 15 having a short upper outer arm 16a and a short lower inner arm 18a (see FIG. 4A) attached a left mounting flange 14a, and a short upper inner arm 22a (see FIG. 3A) and a short lower outer arm 24a attached to a right mounting flange 20a. Generally, the mounting brackets 15 are two identical mounting brackets, with one of the mounting brackets rotated 180 to telescopingly engage the other mounting bracket 15, but as long as the mounting brackets have cooperating arms, they may otherwise be different mounting brackets.

The wide telescoping box bracket 10a has elements similar to the narrow telescoping box bracket 10a, except the mounting brackets have longer arms.

The narrow telescoping box bracket 10a is preferably a sixteen inch telescoping box bracket suitable for spans between vertical studs of up to sixteen inches between centers and the arms of the telescoping box bracket 10a are preferably about ten inches long. The wide telescoping box bracket 10b is preferably a twenty four inch telescoping box bracket suitable for spans between vertical studs of up to twenty four inches between centers and the arms of the telescoping box bracket 10b are preferably about fourteen inches long. Although sixteen and twenty four inches are preferred lengths, brackets of any length having cooperating telescoping arms and a sliding mount as described herein are intended to come with in the scope of the present invention.

A perspective view of the narrow telescoping box bracket 10a according to the present invention in an extended position is shown in FIG. 3, a front view of the narrow telescoping box bracket 10a in an extended position is shown in FIG. 4A, a top view of the narrow telescoping box bracket 10a in an extended position is shown in FIG. 4B, and an end view of the narrow telescoping box bracket 10a in an extended position is shown in FIG. 4C. The upper outer and inner arms 16a and 22a respectively are shown passing through mouths 26 formed in mouth frames 27 in the sliding mount 12.

Points 13 on a rear inside edge of each mouth 26 may initially be bent to the side, if necessary, to allow sliding the sliding mount 12 along the telescoping arms. Once the box bracket 10a or 10b is assembled, the sliding mount 12 is free to slide the length of the telescoping arms for positioning the electrical box. When the sliding mount 12 is in a desired position, the mouth frames 27 may be bent inward to engage the points 13 with a rear surface of the arms to lock the position of the sliding mount 12, or if the points 13 were bent to allow the sliding mount 12 to slide on the arms, the points 13 may be straightened to contact the arms to resist sliding of the sliding mount 12 on the arms. The ability to bend (or adjust) the mouth frames 27 and points 13 allows the sliding mount 12 to be positioned over the larger outer arms or over the smaller inner arms, or over a combination of the outer and inner arms. Unlike known box brackets, the sliding mount 12 of the present invention may thus reside at any location along the arms 16a, 18a, 22a, and 24a, including against a vertical stud.

A perspective view of the narrow mounting bracket 14a according to the present invention is shown in FIG. 5, a top view of the narrow mounting bracket 14a is shown in FIG. 6A, an end view of the narrow mounting bracket 14a is shown in FIG. 6B, and a top view of the narrow mounting bracket 14a is shown in FIG. 6C. The left and right brackets are preferably identical or functionally equivalent parts, although either the right or left mounting bracket, or both may have additional features not shown here. When used as the left bracket, the left upper telescoping arm is the larger cross-section arm and the smaller right upper telescoping arm slides inside the left upper telescoping arm. The identical right bracket is rotated 180 degrees providing a larger right lower telescoping arm for the smaller left lower telescoping arm to slide. As a result, only a single bracket half is required for both right and left sides. Preferably the arms and the flange are formed separately and then assembled to make the mounting bracket, and those skilled in the art will recognize various ways to manufacture the mounting bracket, and a mounting bracket manufactured by any method is intended to come within the scope of the present invention.

The flange 14a (and 20a) has a flange height H_{f} of preferably approximately 6.59 inches. The narrow mounting bracket has an overall width W_{md} of preferably approximately 10.11 inches (14.11 inches for the wide mounting bracket) and the arms 16a and 18a of the narrow mounting bracket have an overall width Wmd of preferably approximately ten inches (fourteen inches for the wide mounting bracket). The arms have an arm depth Dₐ and an arm height Hₐ. The depth Dₐ for an outside arm is between approximately 0.59 and 0.62 inches and the depth Dₐ for an inside arm is between approximately 0.545 inches and the 0.565 inches. The height Hₐ for an outside arm is between approximately 0.679 and 0.709 inches and the height Hₐ for an inside arm is between approximately 0.653 inches and the 0.673 inches. The top and bottom edges of the arms are approximately vertically aligned with the top and bottom edges of the flange 14a.

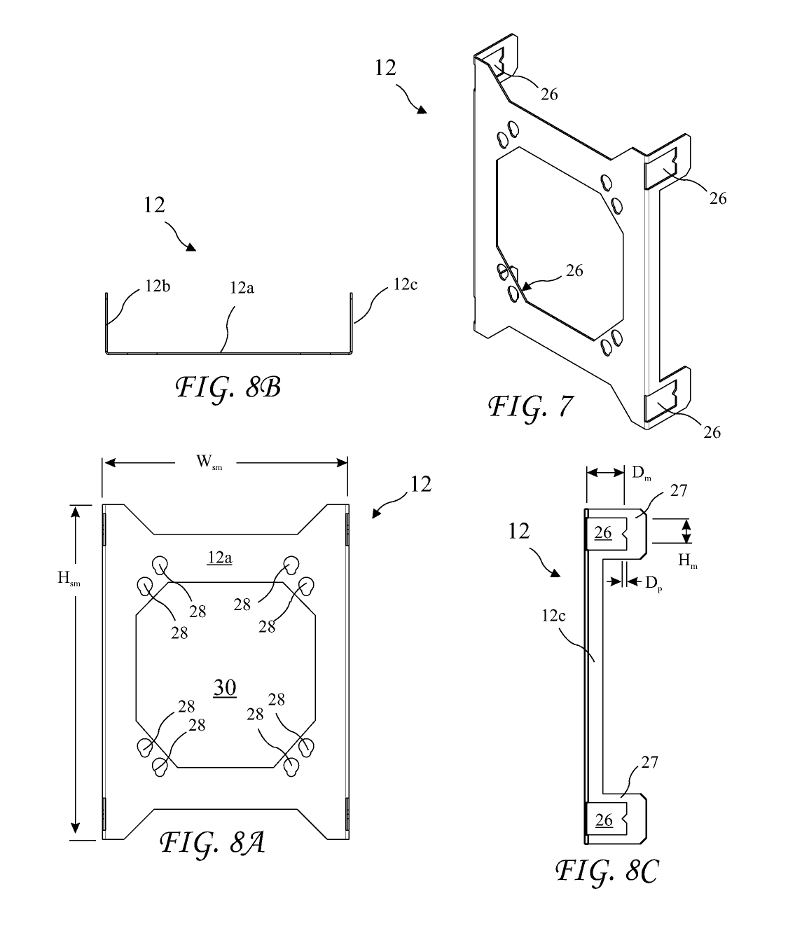

A perspective view of a sliding mount 12 of the telescoping mounting bracket according to the present invention is shown in FIG. 7, a front view of the sliding mount 12 is shown in FIG. 8A, a top view of the sliding mount 12 is shown in FIG. 8B, and an end view of the sliding mount 12 is shown in FIG. 8C. The sliding mount 12 has a face 12a and left and right sides 12b and 12c respectively. The sides 12b and 12c are bent back approximately 90 degrees from the face 12a during fabrication. The face 12a includes keyed mounting holes 28 for attaching the electrical box and a passage 30 for access to the interior of the electrical box. The locations of the holes 28 are for a standard electrical box. The side 12b and 12c include the mouth frames 27 reaching back away from the face 12a, and the mouths 26 are formed in the mouth frames 27.

The sliding mount 12 has a height Hₛₘ and a width Wₛₘ. The height Hₛₘ is preferably approximately seven inches and the width Wₛₘ is preferably approximately 5.16 inches. The mouths 26 have a height Hₘ and a depth Dₘ. The height Hₘ is preferably between approximately 0.672 inches and approximately 0.682 inches and the depth Dₘ is preferably approximately 0.88 inches. The point 13 has a height Hₚ which is preferably approximately 0.1 inches. The dimensions for the arms and the sliding brackets are approximate and those skilled in the art will recognize that there dimensions may be consistently varied and still come within the scope of the present invention.

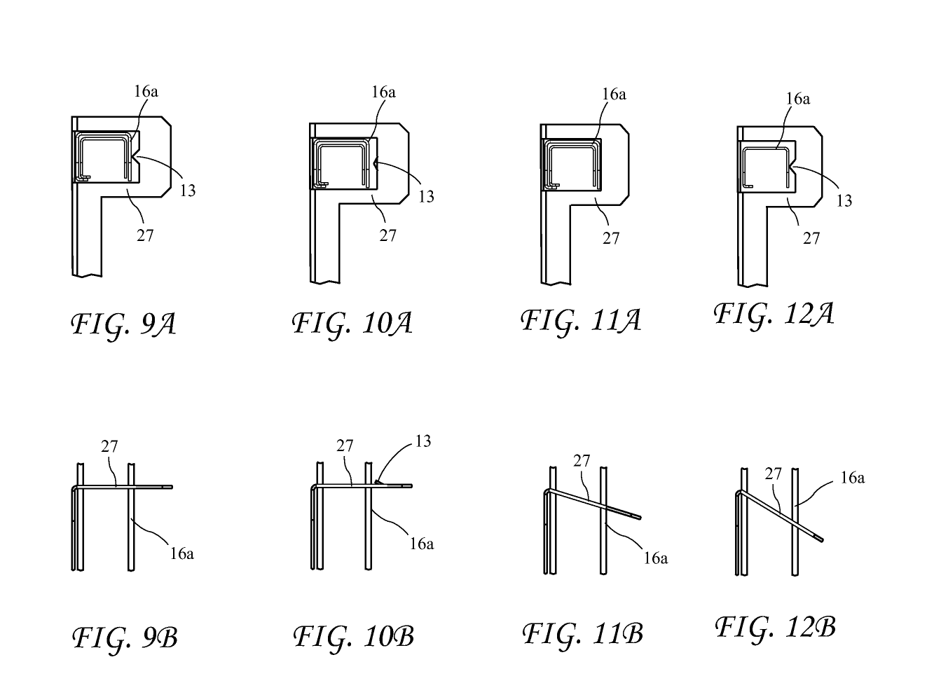

A side view of an arm 16a of the mounting bracket 14a passing through a mouth 26 in a mouth frame 27 of the sliding mount 12 is shown in FIG. 9A and a top view of the arm 16a of the mounting bracket 14a passing through the mouth 26 in the mouth frame 27 of the sliding mount 12 is shown in FIG. 9A. Depending on if the point 13 is in contact with the arm 16a, the sliding mount may or may not be able to slide freely on the arm.

A side view of the arm 16a of the mounting bracket 14a passing through the mouth 26 in a mouth frame 27 of the sliding mount 12 with the point 13 bent away from the arm is shown in FIG. 10A and a top view of the arm 16a of the mounting bracket 14a passing through the mouth 26 in the mouth frame 27 of the sliding mount 12 with the point 13 bent away from the arm is shown in FIG. 10A. With the point 13 bent away from the arm, the sliding mount 12 is free to slide on the arm to position the sliding mount.

A side view of the arm 16a of the mounting bracket 14a passing through the mouth 26 in a mouth frame 27 of the sliding mount 12 with the mouth frame 17 bent towards the arm is shown in FIG. 11A and a top view of the arm 16a of the mounting bracket 14a passing through the mouth 26 in the mouth frame 27 of the sliding mount 12 with the mouth frame 17 bent towards the arm is shown in FIG. 11A. The mouth frame is in contact with the arm, resisting sliding the sliding mount on the arm, without a point 13 in the mouth 26.

A side view of the arm 16a of the mounting bracket 14a passing through the mouth 26 in a mouth frame 27 of the sliding mount 12 with the mouth frame 17 bent towards the arm is shown in FIG. 12A and a top view of the arm 16a of the mounting bracket 14a passing through the mouth 26 in the mouth frame 27 of the sliding mount 12 with the mouth frame 17 bent towards the arm is shown in FIG. 12A. The point 13 is in contact with the arm, resisting sliding the sliding mount on the arm. The mouth frame 27 may be bent less to contact an outer arm which is larger, and bent more to contact an inner arm which is smaller. The box mounts 10a and 10b thereby allow positioning the sliding mount at any location along the arms, including against the studs.

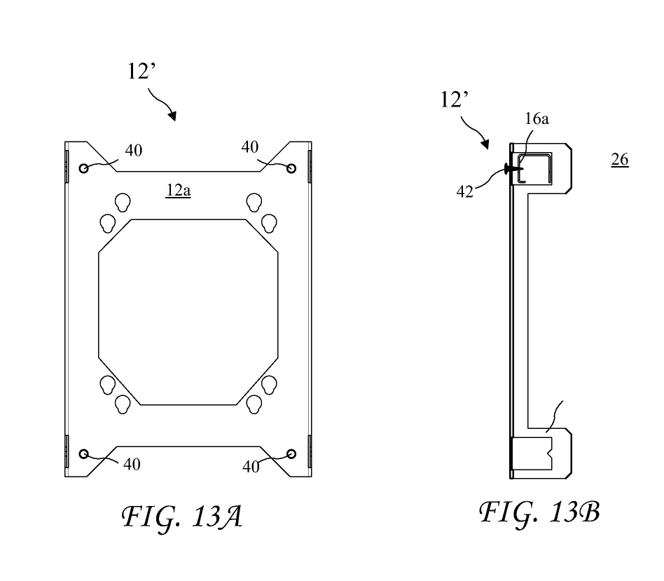

A front view of a second sliding mount 12′ with holes 40 in the face 12a for fixing screws is shown in FIG. 13A and an edge view of the second sliding mount 12′ with screws 42 passing though the holes 40 and engaging the arms 16a for fixing the position of the sliding mount 12′ on the arms is shown in FIG. 13B. The screws 42 are preferably self tapping screws and/or sheet metal screws, but may also be machine screws and the hole 40 may be tapped for the machine screws. The sliding mount 12″ is otherwise is similar to the sliding mount 12.

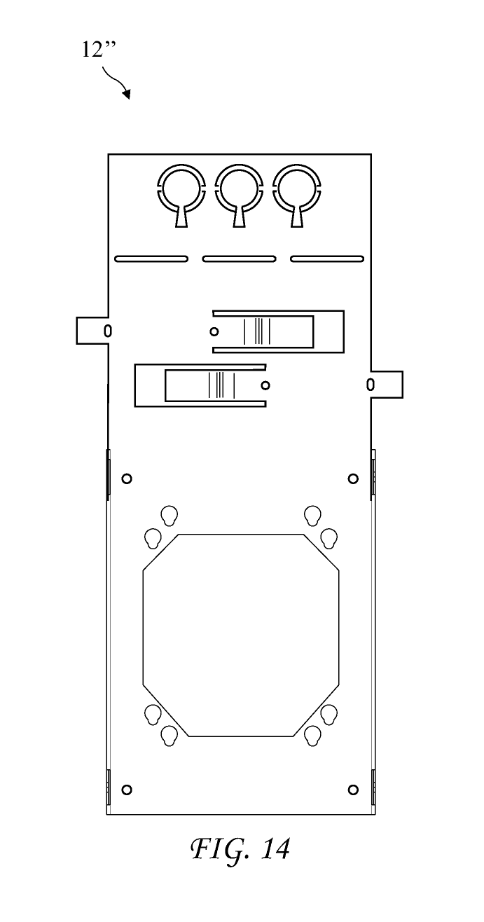

A third sliding mount 12″ including support for EMT and armored cable according to the present invention is shown in FIG. 14. The sliding mount 12″ is otherwise is similar to the sliding mounts 12 and 12′.

The adjustable box bracket is preferably a stamped metal product.

While the invention herein disclosed has been described by means of specific embodiments and applications thereof, numerous modifications and variations could be made thereto by those skilled in the art without departing from the scope of the invention set forth in the claims.

I claim:

1. An adjustable box bracket comprising:
a left mounting bracket comprising:
a left end piece for attaching to a first vertical stud;
a left upper outer arm attached to the left end piece; and
a left lower inner arm attached to the left end piece below and parallel with the left upper outer arm;
a right mounting bracket comprising:
a right end piece for attaching to a second vertical stud adjacent to and spaced apart from the first vertical stud;
a right upper inner arm attached to the right end piece and telescopingly partially residing inside the left upper outer arm; and
a right lower outer arm attached to the right end piece below and parallel with the right upper inner arm and telescopingly partially residing outside the left lower inner arm;
a sliding mount having:
a face for attaching an electrical box; and
right and left sides having vertically spaced apart upper and lower left and right mouths respectively, the upper telescoping arms passing through both right and left upper mouths and the lower telescoping arms passing through both right and left lower mouths,
wherein, the telescoping arms are adjustable to position the end pieces over the studs for attaching to the studs and the sliding mount is slidable along the telescoping arms to position the electrical box at any position along the full lengths of the telescoping arms.

2. The adjustable box bracket of claim 1, wherein:
the right and left mouths are formed in bendable mouth frames, and prior to positioning the sliding mount on the telescoping arms, the bendable mouth frames are bendable away from an adjacent side of one of the telescoping arms to disengage the adjacent side to allow movement of the sliding mount on the telescoping arms; and
after positioning the sliding mount on the telescoping arms, the bendable mouth frames are bendable towards the adjacent side of the telescoping arms to engage the adjacent side to resist movement of the sliding mount on the telescoping arms.

3. The adjustable box bracket of claim 2, wherein:
the right and left mouths includes forward pointing points on rear edges of the mouths;
the points are bendable away from the adjacent side of the telescoping arm to disengage the adjacent side to allow movement of the sliding mount on the telescoping arms, and
the points are bendable towards the adjacent side of the telescoping arm to engage the adjacent side to resist movement of the sliding mount on the telescoping arms.

4. The adjustable box bracket of claim 1, wherein a face of the sliding mount includes fixing screw holes residing over the arms for fixing screws, and the fixing screws are installed through the fixing screw holes to reside against the arms to resist movement of the sliding mount on the telescoping arms.

5. The adjustable box bracket of claim 4, wherein the fixing screw holes comprise four fixing screw holes, one near each corner of the face of the sliding mount.

6. The adjustable box bracket of claim 1, wherein the left upper outer arm, the left lower inner arm, the right upper inner arm, and the right lower outer arm all have a “U” cross-section.

7. The adjustable box bracket of claim 1, wherein:
the left upper outer arm and the right upper inner arm have a downward opening “U” cross-section; and
the left lower inner arm and the right lower outer arm all have an upward opening “U” cross-section.

8. The adjustable box bracket of claim 1, wherein the sliding bracket includes integral strapping for both EMT and armored cable.

9. An adjustable box bracket comprising:
a left mounting bracket comprising:
a left end piece for attaching to a first vertical stud;
a left upper outer arm attached to the left end piece; and
a left lower inner arm attached to the left end piece below and parallel with the left upper outer arm;
a right mounting bracket comprising:
a right end piece for attaching to a second vertical stud adjacent to and spaced apart from the first vertical stud;
a right upper inner arm attached to the right end piece and telescopingly partially residing inside the left upper outer arm; and
a right lower outer arm attached to the right end piece below and parallel with the right upper inner arm and telescopingly partially residing outside the left lower inner arm;
a sliding mount having:
a face for attaching an electrical box;
right and left sides having vertically spaced apart upper and lower left and right mouths respectively, the upper telescoping arms passing through both right and left upper mouths and the lower telescoping arms passing through both right and left lower mouths; and
the right and left mouths formed in bendable mouth frames, wherein:
prior to positioning the sliding mount on the telescoping arms, the bendable mouth frames are bendable away from an adjacent side of one of the telescoping arms to disengage the adjacent side to allow movement of the sliding mount on the telescoping arms; and
after positioning the sliding mount on the telescoping arms, the bendable mouth frames are bendable towards the adjacent side of the telescoping arms to engage the adjacent side to resist movement of the sliding mount on the telescoping arms,
wherein, the telescoping arms are adjustable to position the end pieces over the studs for attaching to the studs and the sliding mount is slidable along the telescoping arms to position the electrical box at any position along the full lengths of the telescoping arms.

10. An adjustable box bracket comprising:
a left mounting bracket comprising:
a left end piece for attaching to a first vertical stud;
a left upper outer arm attached to the left end piece; and
a left lower inner arm attached to the left end piece below and parallel with the left upper outer arm;
a right mounting bracket comprising:
a right end piece for attaching to a second vertical stud adjacent to and spaced apart from the first vertical stud;
a right upper inner arm attached to the right end piece and telescopingly partially residing inside the left upper outer arm; and
a right lower outer arm attached to the right end piece below and parallel with the right upper inner arm and telescopingly partially residing outside the left lower inner arm;
a sliding mount having:
a face for attaching an electrical box;
right and left sides having vertically spaced apart upper and lower left and right mouths respectively, the upper telescoping arms passing through both right and left upper mouths and the lower telescoping arms passing through both right and left lower mouths; and
fixing screw holes residing on the face of the sliding mount over the arms for fixing screws, and the fixing screws are installed through the fixing screw holes to reside against the arms to resist movement of the sliding mount on the telescoping arms,
wherein, the telescoping arms are adjustable to position the end pieces over the studs for attaching to the studs and the sliding mount is slidable along the telescoping arms to position the electrical box at any position between the studs.
